(19) United States
(12) Patent Application Publication
(10) Pub. No.: US 2011/0242348 A1
(43) Pub. Date: Oct. 6, 2011

(54) IMAGING APPARATUS, METHOD OF DISPLAYING, AND PROGRAM

(75) Inventor: Kanako YANA, Tokyo (JP)

(73) Assignee: Sony Corporation, Tokyo (JP)

(21) Appl. No.: 13/028,563

(22) Filed: Feb. 16, 2011

(30) Foreign Application Priority Data
Mar. 30, 2010 (JP) 2010-077445

(51) Int. Cl. H04N 5/228

(52) U.S. Cl. 348/222.1; 348/E05.031

(57) ABSTRACT

An imaging apparatus includes an imaging section outputting an image signal; a detection section detecting coordinates of a contact point of a pointing object on a display section displaying a through-the-lens image on the basis of the image signal; and a control section obtaining, from the detection section, start-point coordinates of a contact point of the pointing object on the display section as a start point, and end-point coordinates of a leaving point of the pointing object from the display section after moving as an end point, holding a line segment determined by the start-point coordinates and the end-point coordinates in a memory, and fixedly displaying, with respect to a display screen of the display section, a line segment corresponding to an edge identified as closest to the line segment among edges of a subject included in the through-the-lens image as a shooting assistance line assisting shooting.

### BACKGROUND OF THE INVENTION

1. Field of the Invention

The present invention relates to an imaging apparatus suitably applied to the cases where, for example, an image of a subject is displayed on a display section and then the image of the subject is captured, a method of displaying, and a program.

2. Description of the Related Art

To date, imaging apparatuses, such as digital still cameras, digital video cameras, etc. have been becoming highly functional, and achieving higher resolutions. In general, imaging apparatuses are provided with a display section, such as a liquid crystal panel, etc., in order to allow a user to check a subject of a photograph immediately. On the display section, not only an image captured by the imaging apparatus, but also various kinds of information (exposure adjustment, shutter speed adjustment, shooting modes, etc.) are displayed as guidance at the time of shooting. Accordingly, the user is allowed to make suitable adjustments while viewing the information at the time of capturing images.

Japanese Unexamined Patent Application Publication No. 2009-290635 has disclosed a technique for recognizing an image, and drawing a shooting assistance line on a display section.

### SUMMARY OF THE INVENTION

Incidentally, a leveling device is sometimes used as an assist function when the horizon, etc., is shot, but it is troublesome to attach the leveling device to an imaging apparatus. Thus, there is a function of displaying horizontal lines and vertical lines (shooting assistance lines) on a screen as an easier function. However, related-art assistance lines are displayed only in a horizontal direction and a vertical direction, and the user is not allowed to move display positions of the assistance lines.

Also, in the technique described in Japanese Unexamined Patent Application Publication No. 2009-290635, the horizon, which is included in an image captured in an imaging section as a subject and is displayed on a display section, is determined, and then a shooting assistance line is displayed. Accordingly, the shooting assistance line follows the image, and thus the user has not been allowed to draw the shooting assistance line at a position intended by the user. Also, it is not possible to display a shooting assistance line when a background lacks a shade of color, or when a boundary between the horizon and the sky is difficult to see, and the like. Also, if the user looks up a building, etc., the contours of the building are not necessarily seen as parallel lines. Accordingly, the shooting assistance line is displayed with being inclined, and thus is no use for determining composition.

The present invention has been made in view of these circumstances. It is desirable to easily position a subject of a photograph.

According to an embodiment of the present invention, there is provided an imaging apparatus.

In the imaging apparatus, an imaging section outputs an image signal, and a detection section detects coordinates of a contact point of a pointing object on a display section displaying a through-the-lens image on the basis of the image signal.

Next, a control section obtains, from the detection section, start-point coordinates of a contact point of the pointing object on the display section as a start point, and end-point coordinates of a leaving point of the pointing object from the display section after moving as an end point, and holds a line segment determined by the start-point coordinates and the end-point coordinates in a memory.

Next, the control section fixedly displays, with respect to a display screen of the display section, a line segment corresponding to an edge identified as closest to the line segment among edges of a subject included in the through-the-lens image as a shooting assistance line assisting shooting.

With this arrangement, it has become possible to fixedly display a line segment corresponding to an edge identified as closest to the line segment among edges of a subject included in the through-the-lens image with respect to a display screen of the display section.

By the present invention, if the user touches the display section with a pointing object, and traces the contour of a subject displayed on the through-the-lens image, a line segment corresponding to an edge identified as closest to the line segment is fixedly displayed with respect to a display screen of the display section among edges of a subject included in the through-the-lens image as a shooting assistance line assisting shooting. Accordingly, it becomes possible for the user to adjust a tilt and a direction of an imaging apparatus in order to align a subject displayed on the through-the-lens image with the shooting assistance line. And the user is advantageously allowed to position the subject easily.

### BRIEF DESCRIPTION OF THE DRAWINGS

FIG. 1 is a block diagram illustrating an example of an internal configuration of an imaging apparatus according to a first embodiment of the present invention;

FIG. 2 is a block diagram illustrating an example of an internal configuration of a control section according to the first embodiment of the present invention;

FIG. 3 is an explanatory diagram illustrating an example of a first operation in the case of displaying a shooting assistance line on a display section according to the first embodiment of the present invention;

FIG. 4 is a flowchart illustrating an example of processing in which a coordinate-acquisition section according to the first embodiment of the present invention obtains coordinates;

FIG. 5 is a flowchart illustrating an example of processing in which the coordinate-acquisition section according to the first embodiment of the present invention writes information into a memory;

FIG. 6 is a flowchart illustrating an example of processing in which the control section according to the first embodiment of the present invention obtains an edge;

FIG. 7 is an explanatory diagram illustrating an example in which two shooting assistance lines according to a second embodiment of the present invention are displayed together with a subject displayed on a through-the-lens image; and

FIG. 8 is an explanatory diagram illustrating an example in which two shooting assistance lines according to another embodiment of the present invention are displayed on the display section.

### DESCRIPTION OF THE PREFERRED EMBODIMENTS

In the following, descriptions will be given of best modes for carrying out the invention (hereinafter referred to as embodiments). In this regard, the descriptions will be given in the following order.

1. First embodiment (display control of shooting assistance line: example of displaying two shooting assistance lines having line symmetry with the vertical direction)

2. Second embodiment (display control of shooting assistance line: example in which a shooting assistance line follows a subject displayed on a through-the-lens image)

3. Variations

### 1. First Embodiment

### Example of Displaying Two Shooting Assistance Lines Having Line Symmetry with the Vertical Direction

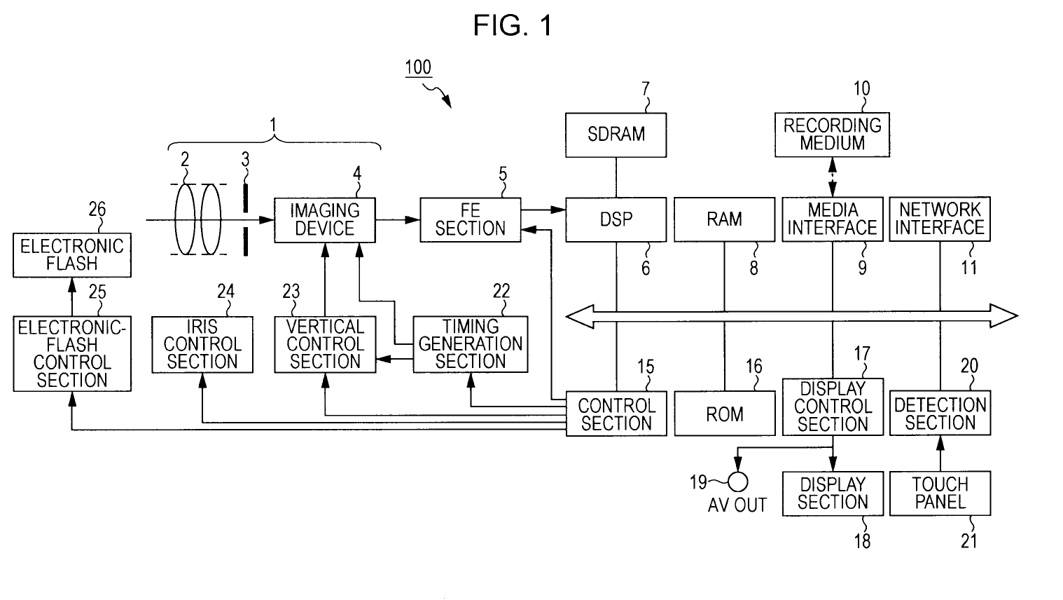

In the following, a description will be given of a first embodiment of the present invention with reference to FIG. 1 to FIG. 6. In the present embodiment, a description will be given of an example in which the present invention is applied to an imaging apparatus 100 capable of input operation through a touch panel.

FIG. 1 illustrates an example of an internal configuration of the imaging apparatus 100. The imaging apparatus 100 includes an imaging section 1 which includes a plurality of lenses, a mechanical shutter, an aperture, etc., and outputs image light of a subject having been transmitted through an optical system 2 and formed on an imaging device 4 as an image signal. The imaging section 1 includes an optical system 2, a shutter/iris 3 performing a shutter operation on image light transmitted through the optical system 2, and the imaging device 4 outputting an analog image signal from the formed image light. For the imaging device 4, for example, a CCD (Charge Coupled Devices) imager or a CMOS (Complementary Metal Oxide Semiconductor) sensor is used.

Also, the imaging apparatus 100 includes a front-end section 5 which adjusts a gain and an exposure of an analog image signal input from the imaging device 4, and converts the signal into a digital image signal, and a DSP 6 performing predetermined signal processing on the digital image signal output from the front-end section 5. The DSP 6 includes an SDRAM (Synchronous Dynamic Random Access Memory) 7 used for image processing, and suitably writes and reads variables, parameters, etc., into and from the SDRAM 7.

Also, the imaging apparatus 100 includes a RAM (Random Access Memory) 8 for use as a work area temporarily saving various kinds of data. Also, the imaging apparatus 100 includes a media interface 9 controlling a recording medium 10, such as a flash memory, etc., to write of read an image obtained from the digital image signal. A commonly used memory card is used for the recording medium 10. Also, the imaging apparatus 100 includes a network interface 11 controlling processing, such as outputting or capturing an image to or from a computer, not shown in the figure, connected through a USB cable.

Also, the imaging apparatus 100 includes a control section 15 controlling operation of each processing block, and a ROM 16 storing a program, etc. Also, the imaging apparatus 100 includes a display control section 17 displaying a through-the-lens image to a display section 18 on the basis of the digital image signal, and an image output section 19 connected to the display control section 17 and outputting an image to an external monitor, etc. Also, the imaging apparatus 100 includes a touch panel 21 on which a user performs input operation using a pointing object, and a detection section 20 detecting coordinates of the pointing object (a user's finger, a stylus pen, etc.) at a contact point on the display section 18 displaying an image on the basis of the image signal. The display section 18 and the touch panel 21 have a size of 3 to 3.5 inches, and a screen aspect ratio that is set to be 16:9.

Also, the imaging apparatus 100 includes a timing generation section 22 generating a timing signal synchronizing operation timing of each section under the control of the control section 15, and a vertical control section 23 controlling vertical reading of the imaging device 4. The vertical control section 23 reads an analog image signal from the imaging device 4 in synchronism with the timing signal supplied from the timing generation section 22. Also, the imaging apparatus 100 includes an iris control section 24 controlling operation timing of the shutter/iris 3, and an electronic-flash control section 25 controlling light-emission timing of an electronic flash 26 emitting electronic-flash light onto a subject.

Next, a description will be given of operation of each section of the imaging apparatus 100.

When the user presses a shutter button, not shown in the figure, etc., the control section 15 controls the shutter/iris 3 to perform iris operation and shutter operation. Also, if the surrounding environment is dark, the control section 15 controls the electronic-flash control section 25 to cause the electronic flash 26 to emit electronic-flash light. A program running on the control section 15 is suitably read from the ROM 16, and control parameters, etc., are written into the RAM 8 to perform processing.

The image light of a subject, which has passed through the optical system 2, undergoes amount-of-light adjustment by the shutter/iris 3, and forms an image on the imaging device 4. The imaging device 4 outputs an analog image signal from the formed image light, and the front-end section 5 converts the analog image signal into a digital image signal, reduces noise, amplifies the digital image signal, and performs the other processing. A timing at which the analog image signal is read from the imaging device 4, and a timing at which the front-end section 5 outputs a digital image signal is controlled by the control section 15. When the DSP 6 receives the digital image signal from the front-end section 5, the DSP 6 performs various kinds of correction processing, and stores the image based on the output digital image signal through the media interface 9 into the recording media 10. The DSP 6 in the present embodiment is used as an edge extraction section which extracts contours of the subject from the through-the-lens image input from the front-end section 5 as edge information, and outputs the extracted edge information to the control section 15 (an assistance-line adjustment section 33 described later). The operation of the DSP 6 to extract edge information is performed by an instruction of the assistance-line adjustment section 33.

Also, the DSP 6 outputs the digital image signal to the display control section 17, and displays the through-the-lens image of the subject not yet saved into the recording media 10 by a shutter operation onto the display section 18. Also, the user can perform setting of operation on the imaging apparatus 100 by touching the touch panel 21 with the pointing object. The setting includes changing of a menu screen and changing of shooting mode, etc. And when the control section 15 receives coordinates of the pointing object having touched the touch panel 21 from the detection section 20, the control section 15 controls each section to operate in accordance with the instruction. Also, the control section 15 controls the display control section 17 to display various kinds of information to the display section 18.

Also, the control section 15 obtains, from the detection section 20, start-point coordinates of a position at which the pointing object touches the display section 18 (touch panel 21) as a start point and end-point coordinates of a position at which the pointing object leaves the display section 18 (touch panel 21) after moving as an end point. Next, the control section 15 holds a plurality of line segments determined by the start-point coordinates and the end-point coordinates in the RAM 8. Next, the control section 15 selects a line segment corresponding to an edge identified as closest to the line segment from the edges obtained from the edge information of the subject included in the through-the-lens image as a shooting assistance line assisting shooting, and fixedly displays the shooting assistance line on the display screen of the display section 18.

Also, when not less than two line segments having different slopes are specified, the control section 15 according to the present embodiment performs processing to adjust the slopes of the two line segments. At this time, when the DSP 6 has extracted two edges having different slopes, the control section 15 adjusts a slope of an axis of symmetry with which at least two line segments close to two edges have line symmetry out of a plurality of line segments held in the RAM 8. That is to say, the control section 15 adjusts the slope of the axis of symmetry so as to be parallel with the horizontal direction or the vertical direction of the display screen of the display section 18, and also adjusts the slopes of the two line segments. And the control section 15 instructs the display control section 17 to display the line segments having the adjusted slopes to the display section 18.

Also, when a USB cable is connected to the network interface 11, the control section 15 outputs an image read from the recording media 10 to the network interface 11 in accordance with an instruction by an external computer, etc.

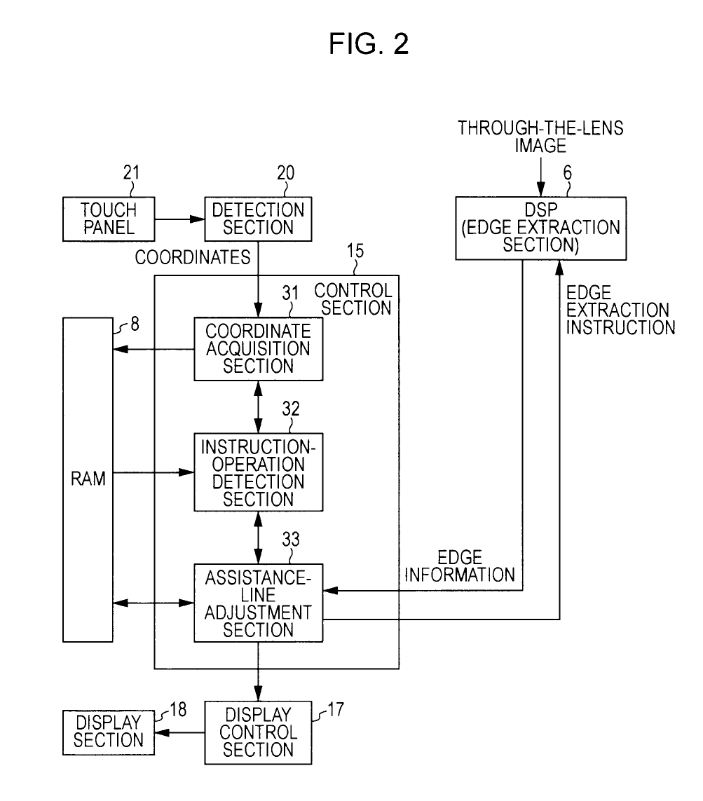

FIG. 2 illustrates an example of an internal configuration of the control section 15.

The control section 15 includes a coordinate acquisition section 31 which obtains coordinates of the pointing object touched (ON) the touch panel 21 from the detection section 20. The coordinate acquisition section 31 stores the coordinates of the pointing object at the moment of touching the touch panel 21 as a start-point position into the RAM 8. Also, the control section 15 includes an instruction-operation detection section 32 which detects a state of the pointing object touching the touch panel 21 from the moment that the coordinate acquisition section 31 obtained the coordinates of the start-point position. And the control section 15 includes an assistance-line adjustment section 33 adjusting the slope of the shooting assistance line in accordance with the through-the-lens image.

The coordinate acquisition section 31 writes start-point coordinates at which the pointing object touched the touch panel 21 out of the coordinates received from the detection section 20 into a first storage area of the RAM 8. Also, the coordinate acquisition section 31 overwrites the coordinates changing with movement of the pointing object keeping in contact with the touch panel 21 into a second storage area of the RAM 8 until reaching to the end-point coordinates, and holds start-point coordinates and end-point coordinates determined for each of a plurality of line segments in the RAM 8.

When the instruction-operation detection section 32 receives notification that the pointing object has touched the touch panel 21 from the coordinate acquisition section 31, the instruction-operation detection section 32 keeps detecting the contact state until the pointing object leaves (OFF) the touch panel 21. And when the pointing object has reached the end-point coordinates, and a movement distance obtained by the start-point coordinates and the end-point coordinates read from the RAM 8 is a threshold value or more, the instruction-operation detection section 32 detects that the pointing object has performed an instruction operation to display the shooting assistance line on the display section 18.

The assistance-line adjustment section 33 obtains an edge from the edge information received from the DSP 6, and instructs the display control section 17 to fixedly display a line segment corresponding to an edge identified closest to the line segment out of edges of a subject included in a through-the-lens image to the display screen of the display section 18 as a shooting assistance line. And the display section 18 displays the shooting assistance line on the screen under the control of the display control section 17.

The instruction to display the shooting assistance line on the display section 18 is displayed on the display section 18, and is carried out by pressing an icon displayed through the touch panel 21 using the pointing object. Alternatively, the display instruction may be carried out by a lapse of a certain time period after the instruction to input a line segment is given by a pointing object.

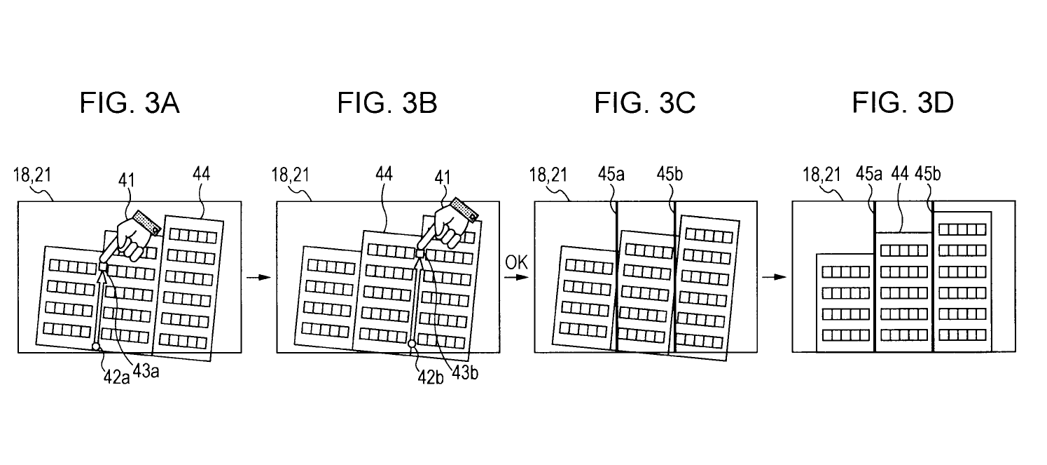

FIG. 3 illustrates an example of operation of the case where a shooting assistance line is displayed on the display section 18.

In the present embodiment, the touch panel 21 is disposed so as to overlap the upper surface of the display section 18. Accordingly, it is assumed that a display range for displaying an image on the display section 18 is substantially equal to a detection range for the touch panel 21 detecting a touch of a pointing object. And the control section 15 gives an instruction to display a line segment passing through start-point coordinates and end-point coordinates as a shooting assistance line on the display section 18.

FIG. 3A illustrates an example of operation in which a user touches the touch panel 21 with a finger 41 to specify a position of the shooting assistance line.

It is assumed that coordinates at which the finger 41 first touched on the touch panel 21 are determined as a start-point position 42a. In the following, a description will be given using the finger 41 as the pointing object. However, the other pointing object, such as a stylus pen, etc., may be used. The user moves the finger 41 upward along the vertical-direction contour of a subject 44 included in a through-the-lens image from the bottom.

When the finger 41 touches the touch panel 21, the coordinate acquisition section 31 keeps writing the obtained coordinates of the 41 into the RAM 8. And when the finger 41 leaves the touch panel 21, the coordinates at which the finger 41 has left are determined to be an end-point position 43a. And the instruction-operation detection section 32 obtains a movement distance of the finger 41 from the start-point position 42a to the end-point position 43a. In this regard, the start-point position 42a and the end-point position 43a are displayed for the convenience of the explanation, and thus these figures are not displayed on the display section 18 while the finger 41 is moving. Also, the shooting assistance line is not displayed on the display section 18 only by the instruction operation in FIG. 3A.

FIG. 3B illustrates an example of operation specifying another position of a shooting assistance line by the user touching the touch panel 21 with a finger 41.

In this example, a building is displayed on the display section 18 as a subject 44. However, it is difficult for the user to vertically shoot the building even if the user uses a tripod, etc. Accordingly, the user specifies a position at which a shooting assistance line is displayed along another contour of the subject 44 in the same manner as the operation shown in FIG. 3A.

FIG. 3C illustrates an example in which shooting assistance lines 45a and 45b are displayed on the display section 18.

When the user presses an OK icon, which is not shown in the figure but is displayed on the display section 18 through the touch panel 21, the shooting assistance lines 45a and 45b having changed slopes from the line segments instructed by the user so far are displayed. The axis of symmetry of the shooting assistance lines 45a and 45b is parallel to the vertical line of the display section 18. In this regard, the shooting assistance lines 45a and 45b may be displayed in red, etc., so that the shooting assistance lines 45a and 45b become more conspicuous than the subject 44 does.

FIG. 3D illustrates a state in which the contours of the subject 44 in the vertical direction match the shooting assistance lines 45a and 45b.

When the shooting assistance lines 45a and 45b are displayed on the display section 18, the user changes the direction and the focus of the imaging apparatus 100 such that the shooting assistance lines 45a and 45b match the contours of the subject 44. Thereby, it is possible for the user to shoot the subject 44 having a correct vertical direction.

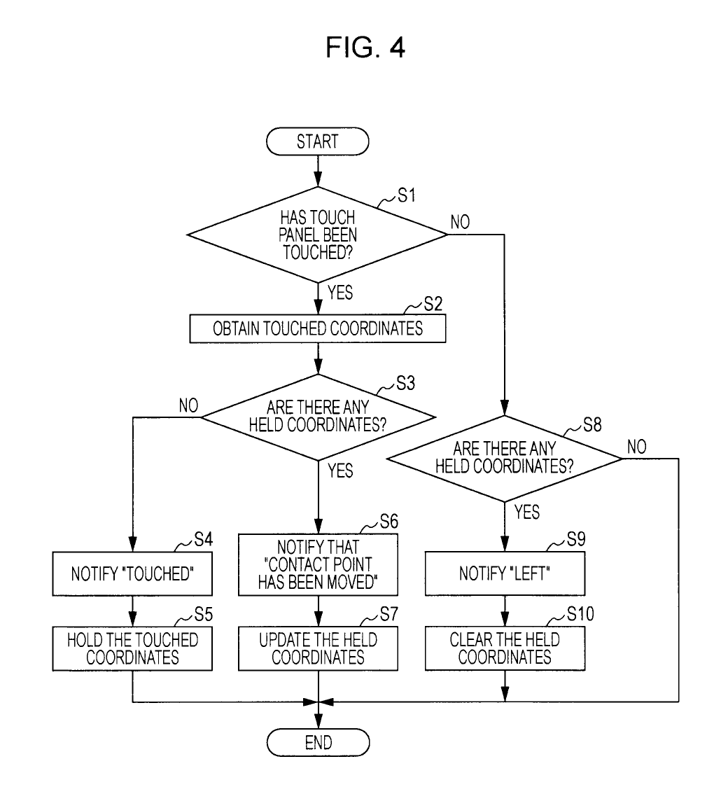

FIG. 4 illustrates an example of processing in which the coordinate acquisition section 31 obtains coordinates.

First, the user traces the subject displayed on the screen so as to specify the subject, and instructs a line segment on which a shooting assistance line is to be displayed. On the basis of the information, the imaging apparatus 100 holds the line segment data to be a basis of a shooting assistance line to be displayed on the display section 18 in the RAM 8. A detailed description will be given of the processing as follows.

First, the coordinate acquisition section 31 determines whether the pointing object (the finger 41 in this example) has touched the touch panel 21 or not (step S1). If determined that the pointing object touches the touch panel 21, the coordinate acquisition section 31 obtains the coordinates of a position where the pointing object has touched (step S2).

Next, the coordinate acquisition section 31 determines whether there are any coordinates held in the RAM 8 or not (step S3). If there are no coordinates held in the RAM 8, the coordinate acquisition section 31 notifies that the pointing object touched the touch panel 21 for the first time to the instruction-operation detection section 32 (step S4). And the coordinate acquisition section 31 writes the touched coordinates into the RAM 8, holds the coordinates as the start-point position (step S5), and the processing terminates.

In the processing in step S3, if determined that there are coordinates held in the RAM 8, the coordinate acquisition section 31 notifies that the position at which the pointing object touches the touch panel 21 has moved to the detection section 32 (step S6). And the coordinate acquisition section 31 writes the coordinates of the pointing object that has moved into the RAM 8, updates the coordinates held in the RAM 8 (step S7), and the processing terminates.

In the processing in step S1, if determined that the pointing object has not touched the touch panel 21, the coordinate acquisition section 31 determines whether there are any coordinates held in the RAM 8 (step S8). If there are coordinates held in the RAM 8, the coordinate acquisition section 31 notifies that the pointing object has left the touch panel 21 to the instruction-operation detection section 32 (step S9). And the coordinate acquisition section 31 clears the coordinates held in the RAM 8, and the processing terminates (step S10).

In the processing in step S8, if determined that there are no coordinates held in the RAM 8, the processing of the coordinate acquisition section 31 terminates.

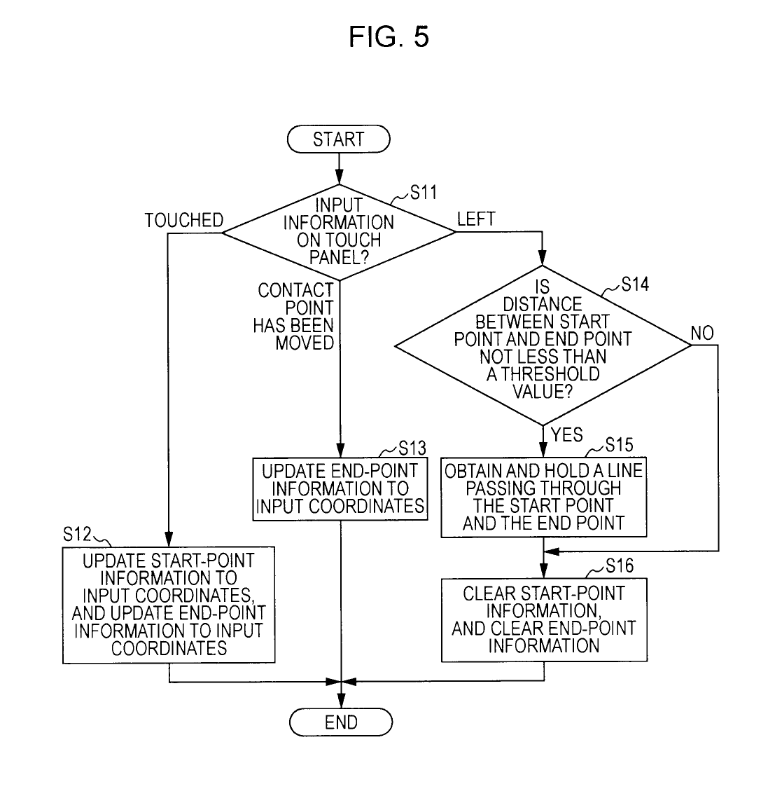

FIG. 5 illustrates an example of processing in which the coordinate acquisition section 31 writes information into the RAM 8.

As the processing here, the imaging apparatus 100 obtains a start point (touched point) and an end point (left point) that the pointing object traced on the touch panel 21 on the basis of the obtained input information. At this time, if the movement distance from the start point to the end point is a threshold value or more, a line segment passing through the start point and the end point is obtained, and is held in the RAM 8. Here, if a plurality of inputs are received, the individual line segments are held in the RAM 8. In the following, a detailed description will be given of the processing.

First, the instruction-operation detection section 32 determines the information input into the touch panel 21 on the basis of the information received from the coordinate acquisition section 31 (step S11). And if determined the pointing object has touched the touch panel 21, the instruction-operation detection section 32 notifies that the pointing object has touched the touch panel 21 to the coordinate acquisition section 31. And the coordinate acquisition section 31 updates the start-point information and the end-point information to the coordinates (called “input coordinates”) at the point when the pointing object touched (step S12), and the processing terminates.

In the processing in step S11, if determined that the pointing object has moved on the touch panel 21, the instruction-operation detection section 32 notifies that the pointing object has moved on the touch panel 21 to the coordinate acquisition section 31. And the coordinate acquisition section 31 updates the end-point information to the input coordinates (step S13), and the processing terminates.

In the processing in step S11, if determined that the pointing object has left the touch panel 21, the instruction-operation detection section 32 determines whether the distance between the start point and the end point (the movement distance of the pointing object) is a threshold value or more (step S14).

If determined that the distance between the start point and the end point is a threshold value or more, the instruction-operation detection section 32 notifies that the distance between the start point and the end point is a threshold value or more to the coordinate acquisition section 31. And the coordinate acquisition section 31 obtains a line segment passing through the start point and the end point, and holds the position information of the line segment in the RAM 8 (step S15). After that, the start-point information and the end-point information are cleared from the RAM 8 (step S16), and the processing terminates.

If determined that the distance between the start point and the end point is less than the threshold value, the instruction-operation detection section 32 bypasses step S15, clears the start-point information and the end-point information from the RAM 8 (step S16), and the processing terminates.

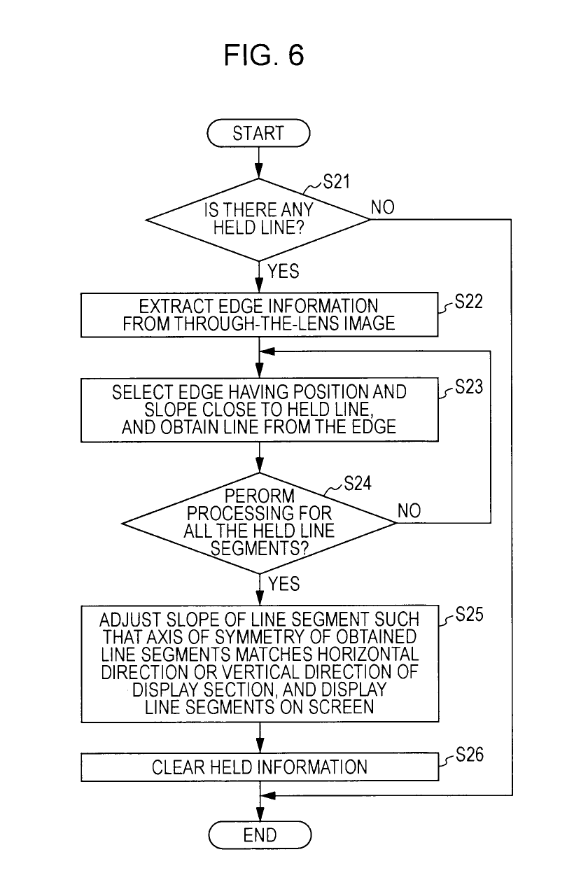

FIG. 6 illustrates an example of processing to display a shooting assistance line on the display section 18.

When the user completes operation of inputting line segments and instructs to display the shooting assistance line, the DSP 6 obtains edge information from the through-the-lens image captured by the imaging device 4. And the assistance-line adjustment section 33 selects a line segment close to an edge of a subject obtained from the edge information from the RAM 8. Further, the assistance-line adjustment section 33 adjusts slopes of individual line segments such that the axis of symmetry of the line segments match the horizontal line or the vertical line of the display screen of the display section 18, and the line segments have line symmetry. And the assistance-line adjustment section 33 displays the line segments on the screen of the display section 18 as shooting assistance lines. In the following, a detailed description will be given of the processing.

The assistance-line adjustment section 33 determines whether the RAM 8 includes line segment data or not (step S21) by the instruction operation of the pointing object detected by the instruction-operation detection section 32. If the RAM 8 does not include line segment data, the processing terminates.

If the RAM 8 includes line segment data, the assistance-line adjustment section 33 instructs a DSP 6 to be used as an edge extraction section to extract edge information from the through-the-lens image, and the DSP 6 extracts edge information from the through-the-lens image (step S22). And the DSP 6 passes the extracted edge information to the assistance-line adjustment section 33.

Next, the assistance-line adjustment section 33 adjusts the slopes of the two line segments such that the axis of symmetry of at least two line segments, out of the obtained line segments, having line symmetry matches the horizontal line or the vertical line of the display screen of the display section 18. And the assistance-line adjustment section 23 instructs to display the shooting assistance line having the adjusted slope to the display section 18 (step S25).

And the assistance-line adjustment section 33 deletes the line segment data held in the RAM 8 (step S26), and the processing terminates.

By the above-described imaging apparatus 100 according to the first embodiment, it becomes possible for the user to fixedly display a shooting assistance line on the display screen of the display section 18 only by touching the touch panel 21 with a pointing object, and tracing in a predetermined direction during shooting. At this time, it is therefore possible for the user to display the shooting assistance line while viewing an image of a subject displayed on the display section 18. Thus, not only immediate responsiveness is improved, but also the advantage of not suspending shooting operation is obtained.

Also, it is possible to fixedly display a shooting assistance line matching a subject included in a through-the-lens image with any slope on the display section 18. Accordingly, it is possible to easily position the subject, and thus it becomes advantageously easy to determine a composition. Also, it becomes possible to hold a plurality of line segments in the RAM 8, to obtain a line segment close to an edge extracted from a through-the-lens image, and to display the line segment as a shooting assistance line. Accordingly, it becomes easy to display a shooting assistance line that meets the user's intention.

In this regard, the number of the line segments for displaying a shooting assistance line is not limited to two, and an even number of line segments may be used.

### 2. Second Embodiment

Example in which a Shooting Assistance Line Follows a Subject Displayed on a Through-the-Lens Image

Next, a description will be given of an example of operation of the imaging apparatus 100 according to the second embodiment of the present invention.

Referring to FIG. 3, the description has been given of a series of operation from when the user specifies a subject to when an assistance line is displayed. However, in the case where a shooting assistance line is displayed, then the user moves the imaging apparatus 100, and the user instructs to display the assistance line again, edge information may be obtained from the through-the-lens image again, an edge portion matching the displayed assistance line may be extracted, and the assistance line may be displayed again in that vicinity. Here, a description will be given of an example in which a shooting assistance line is displayed on the display section 18 in overlapping relation with a subject 46 having vertical-direction contours that are not parallel with each other.

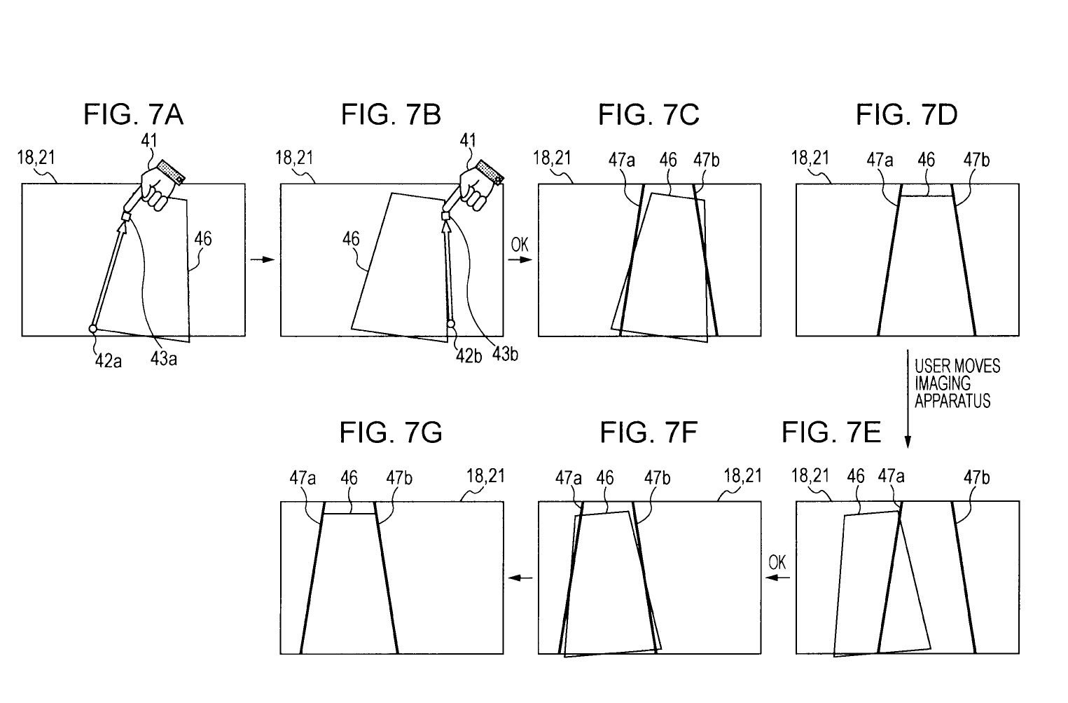

FIG. 7A illustrates an example of operation in which the user touches the touch panel 21 with the finger 41 to specify a position of a shooting assistance line.

This operation is the same as the operation described with reference to FIG. 3A, and thus a description will be omitted.

FIG. 7B illustrates an example of operation in which the user touches the touch panel 21 with the finger 41 to specify another position of a shooting assistance line.

This operation is the same as the operation described with reference to FIG. 3B, and thus a description will be omitted.

FIG. 7C illustrates an example in which shooting assistance lines 47a and 47b have been displayed on the display section 18.

In this example, two shooting assistance lines 47a and 47b are displayed on the display section 18 in overlapping relation with the vertical-direction contours of the subject 46.

FIG. 7D illustrates a state in which the vertical-direction contours of the subject 46 match the shooting assistance lines 47a and 47b.

When the shooting assistance lines 47a and 47b are displayed on the display section 18, the user changes the direction of the imaging apparatus 100 such that the shooting assistance lines 47a and 47b match the contours of the subject 46. Thereby, it is possible for the user to correctly capture the image of the subject 46.

FIG. 7E illustrates a state in which the user has moved the imaging apparatus 100.

In a state in which the shooting assistance line is displayed on the display section 18, when the user moves the imaging apparatus 100, the direction of the imaging section 1 including the optical system 2 toward the subject changes. At this time, the vertical-direction contours of the subject 46 go out of the shooting assistance lines 47a and 47b, and thus the subject 46 shot in this state has a distorted vertical direction.

FIG. 7F illustrates an example in which shooting assistance lines 47a and 47b have followed the movement of the subject 46.

The user presses an icon not shown in the figure to instruct the shooting assistance lines 47a and 47b to move following edges of the subject. At this time, the control section 15 instructs the DSP 6 used as an edge extraction section to extract edge information of the subject 46 from the through-the-lens image again, and the DSP 6 passes the edge information to the assistance-line adjustment section 33. The assistance-line adjustment section 33 obtains edges from the edge information received from the DSP 6, and instructs the display control section 17 to adjust the slopes of the shooting assistance lines displayed on the display section 18 on the basis of the edges, and to display the shooting assistance lines on the display section. At this time, the already-displayed shooting assistance lines 47a and 47b are displayed close to the edges of the subject.

FIG. 7G illustrates a state in which the vertical-direction contours of the subject 46 match the shooting assistance lines 47a and 47b, respectively.

When the shooting assistance lines 47a and 47b are displayed on the display section 18, the user changes the direction of the imaging apparatus 100 such that the shooting assistance lines 47a and 47b match the contours of the subject 46, respectively. Thereby, it is possible for the user to correctly capture the image of the subject 46.

By the above-described imaging apparatus 100 according to the second embodiment, even in the case where shooting assistance lines are displayed on the display section 18 once, and then the direction of the imaging apparatus 100 is changed, the shooting assistance lines are moved in accordance with the movement of the subject 46 included in the through-the-lens image. The following processing is performed only when the user gives the instruction, and thus it becomes advantageous for the user to determine a composition of the subject 46.

### 3. Variations

Also, a position at which the assistance line is displayed is not limited to a position close to a subject displayed on the display section 18. For example, the assistance lines may be displayed on lines that individually trisect the screen vertically and horizontally. That is to say, the assistance lines may be displayed such that a subject specified by the user is disposed on the trisected lines, etc.

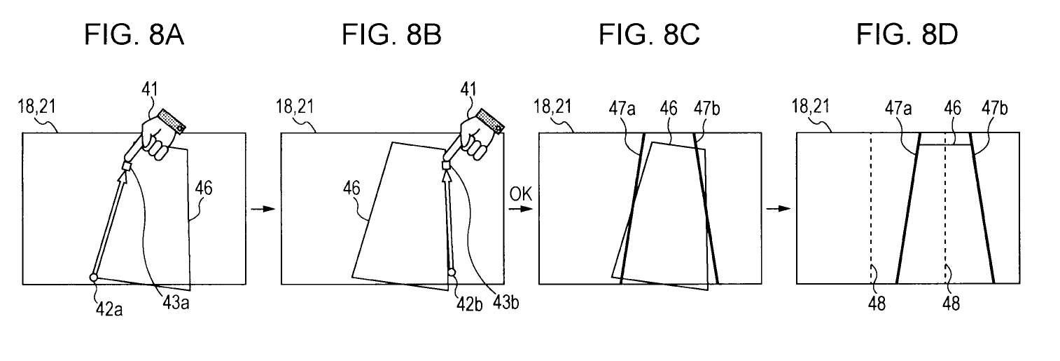

FIG. 8 illustrates an example in which shooting assistance lines 47a and 47b are displayed at trisected positions of the display screen of the display section 18 in the horizontal direction.

FIG. 8A to FIG. 8C are examples of the same operation as those in FIG. 7A to FIG. 7C, and thus detailed descriptions will be omitted.

FIG. 8D illustrates an example in which the shooting assistance lines 47a and 47b are moved, and displayed.

Here, virtual lines 48 indicating that the display screen is trisected in the horizontal direction are denoted on the display section 18. The virtual lines 48 are lines not actually displayed on the display section 18. The control section 15 (assistance-line adjustment section 33) instructs the display control section 17 to display shooting assistance lines such that the axis of symmetry matches a position where the display section 18 is divided into a predetermined number of equal parts (trisected positions in this example) in the horizontal direction or in the vertical direction. As a result, the shooting assistance lines 47a and 47b are displayed such that the axis of symmetry of axis of the shooting assistance lines 47a and 47b is moved to a position matching the virtual line 48. Thereby, it becomes possible to display the shooting assistance lines 47a and 47 so that the subject is positioned at a position which is generally called the golden section and is allowed the subject to be seen and shot with a best balance.

Also, a recording medium, on which program code of the software achieving the function of the above-described embodiments is recorded, may be supplied to the imaging apparatus 100. Also, the same function may of course be achieved by the control section 15 reading and executing the program code stored in a recording medium.

For the recording medium for supplying the program code in this case, for example, a flexible disk, a hard disk, an optical disc, a magneto-optical disc, a CD-ROM, a CD-R, a magnetic tape, a nonvolatile memory card, a ROM, etc., can be used.

Also, by executing program code read by the control section 15, the functions of the above-described embodiments are achieved. In addition, an OS, etc., running in the control section 15 performs part of or all of the actual processing on the basis of the instructions of the program code. The present invention includes the cases where the above-described embodiments are achieved by that processing.

The present application contains subject matter related to that disclosed in Japanese Priority Patent Application JP 2010-077445 filed in the Japan Patent Office on Mar. 30, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging section outputting an image signal;
a detection section detecting coordinates of a contact point of a pointing object on a display section displaying a through-the-lens image on the basis of the image signal; and
a control section obtaining, from the detection section, start-point coordinates of a contact point of the pointing object on the display section as a start point, and end-point coordinates of a leaving point of the pointing object from the display section after moving as an end point, holding a line segment determined by the start-point coordinates and the end-point coordinates in a memory, and fixedly displaying, with respect to a display screen of the display section, a line segment corresponding to an edge identified as closest to the line segment among edges of a subject included in the through-the-lens image as a shooting assistance line assisting shooting.

2. The imaging apparatus according to claim 1,
wherein when two edges having different slopes are extracted, the control section adjusts the slopes of the two line segments, and displays the line segments having the adjusted slopes on the display section such that an axis of symmetry of at least two line segments having line symmetry and close to the two edges is parallel to a horizontal direction or a vertical direction of the display screen among a plurality of the line segments held in the memory.

3. The imaging apparatus according to claim 2,
wherein when the shooting assistance line is displayed on the display section, a direction directed by the imaging section toward the subject changes, and an instruction is given to move the shooting assistance line to follow the edges of the subject,
the control section extracts edge information of the subject from the through-the-lens image again, adjusts the slope of the shooting assistance line displayed on the display section, and instructs to display the shooting assistance line on the display section.

4. The imaging apparatus according to claim 3,
wherein the control section gives an instruction to display the shooting assistance line such that the axis of symmetry is positioned at a position of the display screen divided into a predetermined number of equal parts in a horizontal direction or in a vertical direction.

5. The imaging apparatus according to claim 4,
wherein the instruction to display the shooting assistance line is given by the pointing object pressing an icon displayed on the display section, or by a lapse of a certain time period after the pointing object instructed the line segment.

6. The imaging apparatus according to claim 1,
further comprising an edge extraction section extracting a contour of the subject from the through-the-lens image as the edge information,
wherein the control section includes
a coordinate acquisition section writing the start-point coordinates into a first storage area of the memory out of the coordinates received from the detection section, overwriting the coordinates changing with movement of the pointing object keeping in contact with the display section until the coordinates reach the end-point coordinates, and holding the start-point coordinates and the end-point coordinates determined for each of the plurality of line segments in the memory,
when the pointing object has reached the end-point coordinates, and the movement distance obtained from the start-point coordinates and the end-point coordinates having been read from the memory is not less than a threshold value, an instruction-operation detection section detecting that the pointing object has performed an instruction operation instructing to display the shooting assistance line on the display section, and
an assistance-line adjustment section obtaining edges from the edge information received from the edge extraction section, and instructing to fixedly display a line segment corresponding to an edge identified as closest to the line segment as a shooting assistance line on a display screen of the display section.

7. A method of displaying, comprising the steps of:
outputting an image signal;
detecting coordinates of a contact point of a pointing object on a display section displaying a through-the-lens image on the basis of the image signal; and
obtaining start-point coordinates of a contact point of the pointing object on the display section as a start point, and end-point coordinates of a leaving point of the pointing object from the display section after moving as an end point, holding a line segment determined by the start-point coordinates and the end-point coordinates in a memory, and fixedly displaying, with respect to a display screen of the display section, a line segment corresponding to an edge identified as closest to the line segment among edges of a subject included in the through-the-lens image as a shooting assistance line assisting shooting.

8. A program for causing a computer to perform processing comprising the steps of:
outputting an image signal;
detecting coordinates of a contact point of a pointing object on a display section displaying a through-the-lens image on the basis of the image signal; and
obtaining start-point coordinates of a contact point of the pointing object on the display section as a start point, and end-point coordinates of a leaving point of the pointing object from the display section after moving as an end point, holding a line segment determined by the start-point coordinates and the end-point coordinates in a memory, and fixedly displaying, with respect to a display screen of the display section, a line segment corresponding to an edge identified as closest to the line segment among edges of a subject included in the through-the-lens image as a shooting assistance line assisting shooting.
